(19) United States
(12) Patent Application Publication
(10) Pub. No.: US 2014/0362972 A1
(43) Pub. Date: Dec. 11, 2014

(54) X-RAY GENERATOR AND X-RAY IMAGING APPARATUS

(71) Applicants: Takao Ogura, Yokohama-shi (JP); Miki Tamura, Kawasaki-shi (JP); Tamayo Hiroki, Zama-shi (JP)

(72) Inventors: Takao Ogura, Yokohama-shi (JP); Miki Tamura, Kawasaki-shi (JP); Tamayo Hiroki, Zama-shi (JP)

(73) Assignee: CANON KABUSHIKI KAISHA, Tokyo (JP)

(21) Appl. No.: 14/241,384

(22) PCT Filed: Aug. 8, 2012
(86) PCT No.: PCT/JP2012/072524

§ 371 Date: Feb. 26, 2014

(30) Foreign Application Priority Data
Aug. 31, 2011 (JP) 2011-189224

(51) Int. Cl. H01J 35/08; H05G 1/32; G01N 23/04

(52) U.S. Cl. CPC H01J 35/08; G01N 23/04; H05G 1/32
USPC 378/62; 378/121

(57) ABSTRACT

Provided is an X-ray generator (10) which causes electrons having passed through an electron path (4), formed by an electron path formation member (3) surrounding the periphery of the electron path (4), to be emitted against a target to generate an X-ray, in which: an X-ray generated when the sub X-ray generating portion (5) provided in the electron path (4) is irradiated with the electrons backscatterred off the target is capable of being taken out; a material which constitutes the target and a material which constitutes at least the sub X-ray generating portion (5) of the electron path formation member (3) are the same material of which atomic number is 40 or greater. X-ray generation efficiency can be improved by effectively using the electrons backscatterred off the transmission target.

### TECHNICAL FIELD

The present invention relates to a transmission type X-ray generator applicable to radiography for diagnosis and a non-destructive test in the medical and industrial fields and other use.

### BACKGROUND ART

A transmission type X-ray generator which emits electrons at a transmission target and makes X-rays be generated contributes reduction in device size, but X-ray generation efficiency thereof is significantly low. This is because, when electrons are accelerated to high energy and emitted against the transmission target to make X-rays be generated, the ratio of energy of electrons that become the X-rays is only 1% or less of the entire electrons colliding with the transmission target: the rest, about 99% or more, of the electrons become heat. Therefore, improvement in X-ray generation efficiency is required.

PTL 1 discloses an X-ray tube with improved X-ray generation efficiency. X-ray generation efficiency is improved in the following manner: an anode member provided with a conical channel of which opening diameter is reduced from an electron source toward a target is disposed between the electron source and the target; and electrons are made to be elastically scattered on a channel surface and enter the target.

### CITATION LIST

### Patent Literature

PTL 1 Japanese Patent Laid-Open No. 9-171788

### SUMMARY OF INVENTION

### Technical Problem

In a related art X-ray generator, when the electrons collide with the transmission target, backscattered electrons are generated; most of the backscattered electrons do not contribute to generation of the X-rays. Therefore, X-ray generation efficiency to input power is not sufficiently high.

The present invention provides a transmission type X-ray generator capable of improving X-ray generation efficiency by effectively using electrons backscatterred at a transmission target.

### Solution to Problem

An X-ray generator according to the present invention includes an electron path formed by an electron path formation member surrounding a periphery of the electron path, in which electrons having passed through the electron path are made to be emitted at the target and to generate an X-ray, wherein: a sub X-ray generating portion which generates an X-ray when being irradiated with electrons is provided in the electron path, wherein: the sub X-ray generating portion and the target are disposed in a manner that both an X-ray generated when the electrons are directly emitted at the target, and an X-ray generated when the electrons backscatterred off the target are emitted at the sub X-ray generating portion are made to be emitted outside; and a material which constitutes the target and a material which constitutes at least the sub X-ray generating portion of the electron path formation member are the same material of which atomic number is 40 or greater.

### Advantageous Effects of Invention

According to the present invention, besides X-rays generated at a transmission target, X-rays generated by electrons backscattered off a transmission target and made to be emitted against an electron path formation member may be taken out. A material which constitutes sub X-ray generating portion of an electron path formation member is a material of which atomic number is at least 40. Thus, the amount of the X-rays generated by irradiation of backscattered electron increases. A material which constitutes the transmission target and the material which constitutes at least the sub X-ray generating portion of the electron path formation member are the same with each other. Thus, generated X-rays have the same characteristics. Therefore, generation efficiency of the X-rays that may be used effectively may be improved.

### BRIEF DESCRIPTION OF DRAWINGS

FIG. 1 is a schematic diagram of an X-ray tube applied to an X-ray generator according to the present invention.

FIGS. 2A and 2B are schematic diagrams of a target area according to the present invention.

FIG. 3 is a schematic diagram of an anode according to the present invention.

FIG. 4 is a schematic diagram of another anode according to the present invention.

FIG. 5 is a schematic diagram of yet another anode according to the present invention.

FIGS. 6A and 6B are schematic diagrams of another anode and another target area according to the present invention.

FIGS. 7A and 7B are schematic diagrams of yet another target area according to the present invention.

FIGS. 8A and 8B are schematic diagrams of an X-ray generator and an X-ray imaging apparatus according to the present invention.

### DESCRIPTION OF EMBODIMENTS

Hereinafter, embodiments of the present invention will be described with reference to the drawings. A transmission type X-ray generator (hereafter, “X-ray generator”) of the present invention includes devices which generate other rays, such as neutron beam.

### First Embodiment

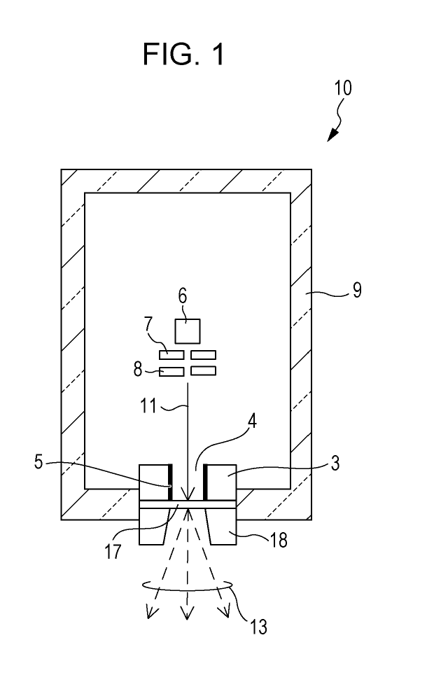

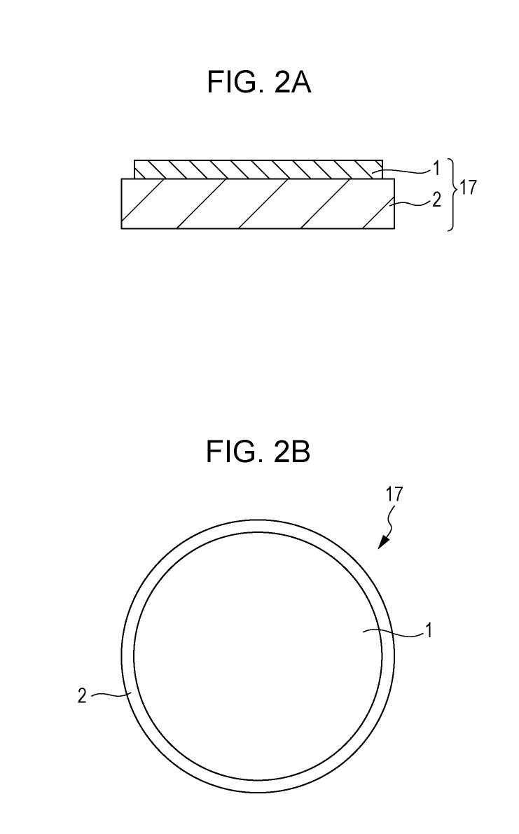

FIG. 1 is schematic diagram of a transmission type X-ray generating tube (hereafter, “X-ray tube”) applied to the present invention. FIGS. 2A and 2B are enlarged views of a target area applied to the X-ray tube.

A vacuum vessel 9 keeps an X-ray tube 10 be vacuumized and is made of, for example, glass or ceramic. The degree of vacuum inside the vacuum vessel 9 is about 10⁻⁴ to 10⁻⁸ Pa. The vacuum vessel 9 is provided with an opening to which an electron path formation member 3 for forming an electron path 4 is attached. The vacuum vessel 9 is sealed by a target area 17 attached to an end surface of the electron path 4. The target area 17 consists of a transmission target 1 (hereafter, “target 1”) and a support substrate 2. The target 1 electrically communicates with the electron path formation member 3. The vacuum vessel 9 may be provided with an unillustrated exhaust pipe. If the exhaust pipe is provided, a vacuum may be produced in the vacuum vessel 9 by, for example, vacuumizing the inside of the vacuum vessel 9 through the exhaust pipe and then sealing a part of the exhaust pipe. An unillustrated getter may be provided inside the vacuum vessel 9 for keeping the degree of vacuum.

An electron emission source 6 is disposed inside the vacuum vessel 9 to face the target 1. The electron emission source 6 may be made of, for example, a tungsten filament, a cold cathode, such as an impregnated cathode, a hot cathode, such as a carbon nanotube. An electron beam 11 emitted from the electron emission source 6 enters from one end of the electron path 4 constituted by the electron path formation member 3, passes through the inside of the electron path 4, and then emitted against the target 1 disposed at the other end of the electron path 4. When the target 1 is irradiated with the electron beam 11, X-rays 13 are generated and are taken out of the vacuum vessel 9. The X-ray tube 10 is provided with an extraction electrode 7 and a focusing electrode 8. Electrons are emitted from the electron emission source 6 in an electric field formed by the extraction electrode 7. The emitted electrons are converged at the focusing electrode 8 and are made to enter the target 1. The voltage Va applied at this time to between the electron emission source 6 and the target 1 depends on the use of the X-rays, and generally is about 40 to 150 kV.

The target 1 is disposed on a surface of the support substrate 2 on the side of the electron emission source. Between the target 1 and the electron emission source 6, the electron path formation member 3 is disposed and the electron path 4 is formed. The electron path formation member 3 surrounds the electron path 4 so that the electron path 4 opens at both ends thereof. An inner wall surface of the electron path formation member 3 serves as a sub X-ray generating portion 5. The sub X-ray generating portion 5 is disposed in a flat shape, and therefore will be referred to as “sub X-ray generation surface.” The sub X-ray generation surface 5 may be formed as a part of the inner wall surface of the electron path formation member 3, or may be formed on a surface of the electron path formation member 3 as a member independent from the electron path formation member 3.

The electrons 11 emitted from the electron emission source 6 pass the electron path 4 and collide with the target 1. Collision of accelerated electrons with the target 1 generates X-rays which pass through the support substrate 2 and are emitted outside the X-ray tube 10. Collision of electrons with the target 1 also generates backscattered electrons. Since the target 1 is made of a material (metal) of which atomic number is 40 or greater, a rate of the reflection of electron is relatively large, i.e., 20 to 60%. The backscattered electrons generated at the target 1 collide with the sub X-ray generation surface 5 and generate X-rays. The X-rays generated at this time (hereafter, “sub X-rays”) pass through the support substrate 2 and are emitted outside the X-ray tube 10. That is, at least a part of the X-rays generated when the backscattered electrons are emitted to the sub X-ray generation surface 5 and the X-rays generated when the electrons are directly emitted to the target 1 pass through the support substrate 2 and are emitted outside the X-ray tube 10.

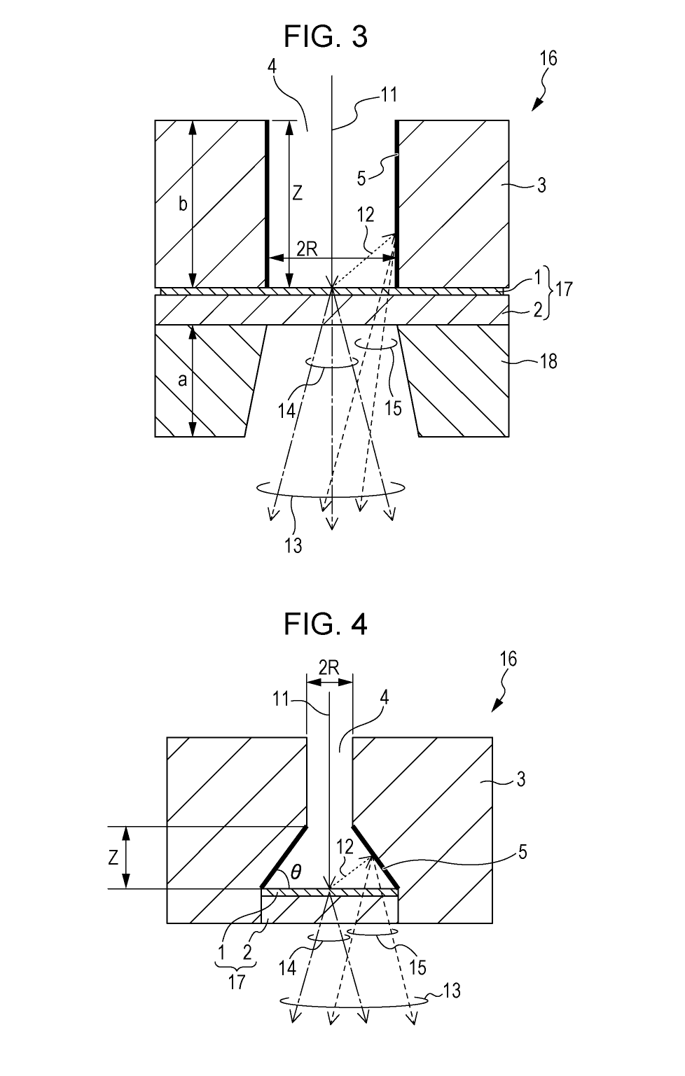

As illustrated in FIG. 3, an anode 16 is constituted by a target area 17 which is formed by the target 1 and the support substrate 2, the electron path formation member 3 and a shielding member 18.

Typically, the target 1 may be made of a metallic material of which atomic number is 26 or greater. Materials having greater thermal conductivity and higher specific heat are more suitable. It is necessary to determine the thickness of the target 1 such that the generated X-rays may pass through the same. The depth to which the electron beam enters, i.e., a generating region of the X-rays, varies depending on the acceleration voltage and the optimum value of the thickness of the target 1 is not particularly determined. Generally, the thickness of the target 1 is 1 to 15 μm. The support substrate 2 may be made of, for example, diamond and the suitable thickness thereof is 0.5 to 5 mm.

The shielding member 18 has a function to take out necessary X-rays through the opening from among the X-rays emitted toward the front side (i.e., in the direction opposite to the electron emission source 6 from the target 1), and shield X-rays which are unnecessary. It is only necessary that the shielding member 18 is made of a material that is capable of shielding X-rays generated at 40 to 150 kV. Desirably, the material of the shielding member 18 is high in absorptivity of the X-rays and high in thermal conductivity. It is suitable that, if tungsten is used in the target 1, for example, tungsten, tantalum or alloys thereof may be used in the shielding member 18. If molybdenum is used in the target 1, molybdenum, zirconium, niobium, for example, besides tungsten and tantalum may be used in the shielding member 18.

The shape of the opening of the shielding member 18 may be circular or may be rectangular. The size of the opening of the shielding member 18 may be determined such that at least necessary X-rays may be taken out. If the opening is circular, the diameter is desirably 0.1 to 3 mm and, if the opening is square, each side is desirably 0.1 to 3 mm. This is because, if the diameter or each side is 0.1 mm or smaller, substantially, the X-ray amount at the time of image pickup is inconveniently lowered and, if 3 mm or greater, substantially, a radiation effect to the shielding member 18 is not easily achieved.

Desirably, the opening of the shielding member 18 is enlarged gradually toward the front side. That is, it is desirable that the opening of the shielding member 18 is enlarged gradually from its target side end toward its end opposite to the target 1. This is because, if the target side end of the opening is narrow, the heat generated at the target 1 is transferred to the shielding member 18 and emitted more promptly and, if the end of the opening opposite to the target 1 is wide, an irradiation area of the X-rays at the time of image pickup may be increased.

It is only necessary that the thickness a of the shielding member 18 is determined such that a shielding effect with which the amount of the emitted X-rays may be reduced to a range in which substantially no problems occur is produced. This thickness varies depending on the energy of the emitted X-rays. For example, if the energy of the X-rays is 30 to 150 keV, it is necessary that the thickness a is at least 1 to 3 mm even if the shielding member is made of tungsten that has a significant shielding effect. The thickness a may be determined arbitrarily to be greater than the above range from the viewpoint of shielding X-rays: however, a range of 3 to 10 mm is more desirable from the viewpoint of heat capacity, cost and weight. However, if a collimator for restricting the X-ray field is provided outside the X-ray tube 10, it is also possible to exclude the shielding member 18.

Besides the function as the sub X-ray generation surface 5, the electron path formation member 3 has a function to shield the X-rays emitted toward the back side (i.e., a direction toward the electron emission source from the target 1). However, since the X-rays which pass through the opening of the electron path formation member 3 and are emitted to the electron emission source side are not able to be shielded, a shielding unit may be provided separately.

In order to efficiently generate the sub X-rays by the electrons backscattered off the target 1 and to make the sub X-rays have the same characteristics as those of the X-rays generated at the target 1, a combination of the material of the target 1 and the material which constitutes at least the sub X-ray generation surface 5 of the electron path formation member 3 is important.

A part of the electrons collided with the target 1 loses a part of incident energy and becomes backscattered electrons, and then collides with the sub X-ray generation surface 5 of the electron path formation member 3. Although desired voltage is applied to the electrons which directly collide with the target 1, the backscattered electrons have lost a part of energy and therefore the voltage being applied thereto is lower than the incidence voltage to the target 1. Generation of the X-rays is affected by voltage, current, and the material at which the electron beam is emitted. Therefore, in order to improve generation efficiency of the X-rays generated by the backscattered electrons, it is necessary that at least the material which constitutes the sub X-ray generation surface 5 of the electron path formation member 3 is a material of which atomic number is 40 or greater. In order to make the X-rays generated at the target 1 and the X-rays generated by the backscattered electrons have the same characteristics, it is necessary that the material which constitutes at least the sub X-ray generation surface 5 of the electron path formation member 3 is the same as the material of the target 1. The target 1 and the electron path formation member 3 may be desirably made of any one of Mo, W and lanthanoid.

Although the electron path formation member 3 and the sub X-ray generation surface 5 are made of the same material in an integrated manner in the present embodiment, it is also possible to form, on the electron path formation member 3, the sub X-ray generation surface 5 made of a material which is different from that of the electron path formation member 3. For example, the material of the target 1 and the material which constitutes the sub X-ray generation surface 5 may be W, and the material of the electron path formation member 3 may be copper (Cu). The thickness of the sub X-ray generation surface 5 is desirably greater than the distance over which the electronic invasion is carried out. In particular, a range of 1 to 100 μm is desirable.

Here, a desirable range of an area in which the sub X-ray generation surface 5 is formed will be described. In a case in which the cross sectional shape of the electron path 4 is circular in FIG. 3, a desirable range of the size (radius=R) and a desirable range of the path length Z of the electron path 4 (i.e., the formation length of the sub X-ray generation surface 5 from the target 1) will be described. A desirable range of the path length Z may be determined in consideration of density distribution of the backscattered electrons having reached the periphery. Many, i.e., about 80% of, reach points of electrons backscatterred at the target 1 exist on a peripheral surface of the electron path of which distance (coordinate) z from the target 1 is 2R or less. About 95% of reach points exist when the distance z is 4R or less. If the distance z is 20R, the reach density of the backscattered electrons converges to about zero. Therefore, when the opening width of the electron path 4 (i.e., the size of the opening of the electron path formation member 3) is set to 2R, it is desirable that the sub X-ray generation surface 5 is formed in an area at which the distance z is at least 2R or less and preferably 4R or less. Desirably, regarding the size 2R of the opening of the electron path formation member 3 and the path length (size) Z of the electron path, the following relationship is satisfied: 2≦Z/R≦20. It is further desirable that the following relationship is satisfied: 4≦Z/R≦20. In the present embodiment, the path length Z is equal to the thickness b of the electron path formation member 3.

It is necessary that the size of the opening of the electron path 4 is determined such that at least the electron beam 11 may be placed therein. The size of the opening is not uniquely determined because a convergence state of the electron beam 11 varies depending on the types of the electron emission source 6 or the types of a focusing electrode 8, if the shape of the electron path 4 is circular, the diameter of the opening is desirably 0.5 to 5.0 mm. It is necessary that the thickness b of the electron path formation member 3 is 1 mm or more in order to achieve the X-ray shielding effect. Therefore, the thickness b is desirably 1 to 25 mm.

Besides the circle, the opening of the electron path formation member 3 may be regular polygon. This is because, since the cross section of the electron beam 11 is circular or rectangular in many cases, it is intended to make the distance from an electron beam irradiation region of the target 1 to the electron path formation member 3 be as equal as possible.

The shielding member 18 is joined to the target area 17 and the target area 17 is joined to the electron path formation member 3 by, for example, soldering, mechanical pressurization and screwing.

### Second Embodiment

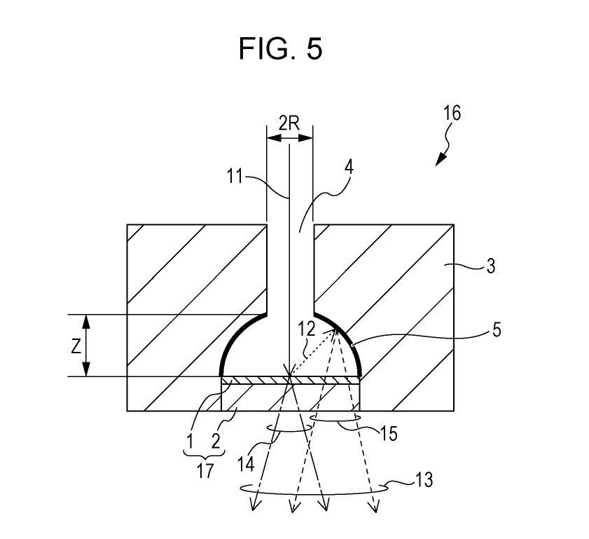

As illustrated in FIG. 4, the cross sectional area of the electron path 4 is enlarged continuously toward target 1. In particular, the electron path 1 at the target 1 side thereof is enlarged continuously toward the target 1 in the shape of cone or trumpet. An inner wall surface of an area in which the cross sectional area of the electron path 4 is enlarged serves as the sub X-ray generation surface 5. It is only necessary that at least a part of the inner wall surface of the area in which the cross sectional area of the electron path 4 is enlarged serves as the sub X-ray generation surface 5.

Next, a desirable shape of the electron path 4 will be described. A desirable range of an angle θ made by the sub X-ray generation surface 5 and the target 1 will be described. If θ is greater than 90 degrees, most of the generated X-rays 15 is absorbed while passing through the sub X-ray generation surface 5 and only a few of the X-rays is emitted outside. If θ equals to 90 degrees, about a half of the generated X-rays 15 are absorbed inside the sub X-ray generation surface 5. If θ is smaller than 90 degrees, most (at least about a half or more) of the generated X-rays 15 is not absorbed and is emitted outside. Therefore, if θ is smaller than 90 degrees, i.e., the cross section of the electron path 4 at the end on the side of the target is larger than that at the end opposite to the target 1, the ratio at which the generated X-rays 15 are absorbed in the sub X-ray generation surface 5 is lowered, whereby the amount of the X-rays 15 to be taken out may be increased.

The desired range of the angle θ may also be determined in consideration of dependence of the X-ray intensity on an emission angle. Generally, electrons accelerated to 10 to 200 kV enter the sub X-ray generation surface 5 into the depth of several μm without being strongly dependent on an incidence angle. Therefore, many sub X-rays are generated in the depth of several μm of the sub X-ray generation surface 5 surface. The sub X-rays are emitted against various angles. If the emission angle φ of the sub X-rays (i.e., an angle from the surface of the sub X-ray generation surface 5) is small, the distance over which the sub X-rays pass through the sub X-ray generation surface 5 is large. Therefore, for example, if φ is smaller than 5 degrees, the X-ray intensity becomes rapidly smaller as φ becomes small. Therefore, if the lower limit of the emission angle is set to φ₀ in consideration of dependence of the X-ray intensity on the emission angle, the desirable range of the angle θ is θ<90−φ₀ in combination with the above-described desirable range. If φ₀ is 5 degrees, θ is smaller than 85 degrees. In consideration of efficient collision, with the inner wall surface, of the electrons backscatterred at the target, the lower limit of θ is 10 degrees<θ. Therefore, a desired range of the angle θ is 10 degrees<θ<85 degrees.

As is the case with the anode 16 related to the first embodiment, it is desirable in the present embodiment that, regarding the size 2R of the opening of the electron path 4 and the formation length Z of the sub X-ray generating portion 5 from the target 1, the following relationship is satisfied: 2R≦Z≦20R. It is further desirable that the following relationship is satisfied: 4R≦Z≦20R.

Although the sub X-ray generation surface 5 is formed on the entire surface of the inner wall of the area in which the cross sectional area of the electron path 4 is enlarged in FIG. 4, the area in which the sub X-ray generation surface 5 is formed is not limited to the same. It is only necessary that the sub X-ray generation surface 5 is formed in an area in which at least the range of desirable length Z described above is included.

In order to cause the backscattered electrons 12 to collide with the sub X-ray generation surface 5 provided in the electron path 4 and to generate the sub X-rays, and then cause the sub X-rays to be taken out of the X-ray tube 10 (see FIG. 1), it is only necessary to dispose the sub X-ray generation surface 5 and the target 1 in the following manner. For example, the sub X-ray generation surface 5 may be disposed to extend over the target 1 on the side at which the electrons are emitted. Alternatively, the sub X-ray generation surface 5 and the target 1 may be disposed such that the X-rays generated when the electrons are emitted directly at the target 1 and the sub X-rays may be taken out in a superimposed manner. In this arrangement, the target 1 may be made of a material at which 20 to 60% of the emitted electrons are backscattered. In these arrangements, the sub X-ray generation surface 5 may be made of a material which is the same as, or different from, that of the electron path formation member 3.

Desirably, the sub X-ray generation surface 5 is shaped such that the amount of the X-rays which are generated by the backscattered electrons being emitted against the sub X-ray generation surface 5, and which pass through the area in which the electrons of the target 1 are emitted is increased.

Material and shape of the target 1, the support substrate 2 and the electron path formation member 3 used in the example illustrated in FIG. 4 are the same as those of the first embodiment illustrated in FIGS. 1 to 3. As is the case with the anode 16 related to the first embodiment, the sub X-ray generation surface 5 made of a material which is different from that of the electron path formation member 3 may be formed on the surface of the electron path formation member 3.

As described above, according to the present embodiment, besides the X-rays 14 generated at the target 1, the X-rays 15 generated by the backscattered electrons 12 generated at the target 1 are taken out efficiently: therefore, X-ray generation efficiency is improved.

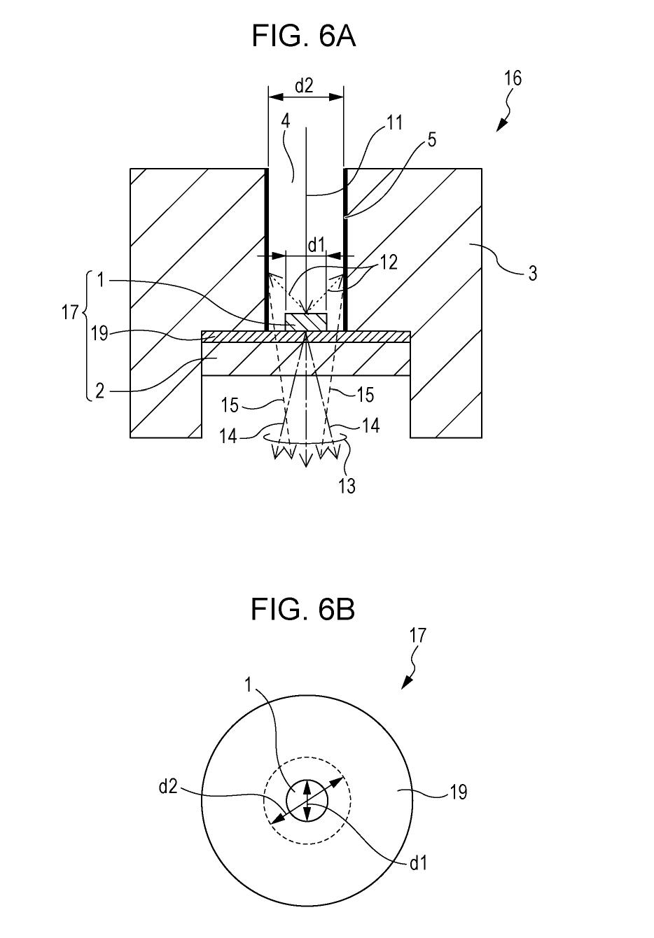

FIG. 5 illustrates a modification of the present embodiment. The electron path 4 in the present modification has a hemispherical shape on the target 1 side thereof. The present modification is the same as the embodiment described above except for the shape of the electron path formation member 3 and the shape of the electron path 4.

### Third Embodiment

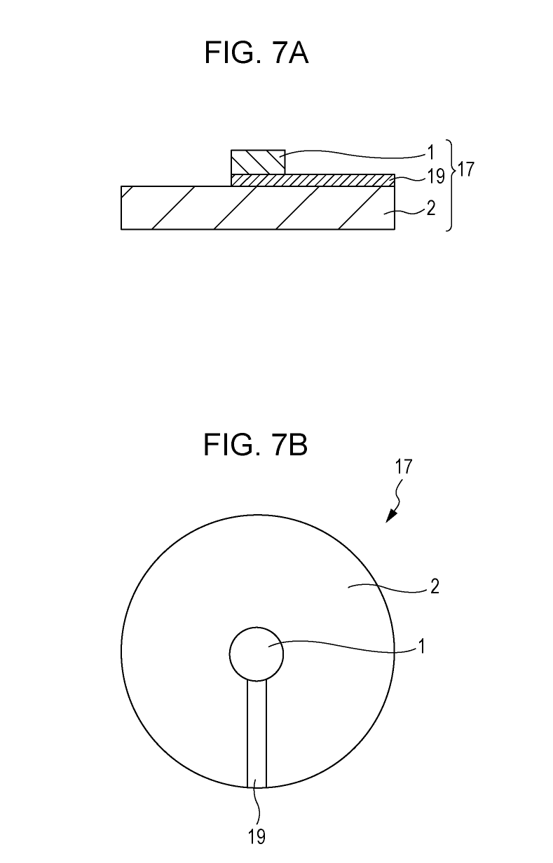

FIGS. 6A and 6B illustrate an anode 16 according to a third embodiment. The anode 16 is constituted by a support substrate 2, a conductive layer 19, a target 1 and an electron path formation member 3. The support substrate 2 functions also as an X-ray transmission window.

For example, the support substrate 2 may be made of diamond, silicon nitride, silicon carbide, aluminium carbide, aluminium nitride, graphite and beryllium. Diamond is particularly desirable because of its lower radiolucency than aluminum and higher thermal conductivity than tungsten. Although it depends on the materials, the thickness of the support substrate 2 is desirably 0.3 to 2 mm.

The conductive layer 19 is provided for the purpose of preventing charge-up of the target area 17 by the electrons when the target 1 is irradiated with the electron beam 11. Therefore, the conductive layer 19 may be made of any conductive material including many kinds of metallic materials, carbide and oxide. The conductive layer 19 is formed on the support substrate 2 by sputtering and vapor deposition. If the support substrate 2 is a conductive material, such as graphite and beryllium, or an insulating material capable of being provided with electrical conductivity by additives, the conductive layer 19 is not necessary. However, commercially available insulating materials, such as diamond, generally have no electrical conductivity, and therefore it is necessary to provide the conductive layer 19. In a case in which the conductive layer 19 is connected to the target 1, it is also possible to supply voltage to the target 1 via the conductive layer 19.

If the conductive layer 19 is provided only for the purpose of preventing charge-up of the target area 17, the conductive layer 19 may be made of any type of materials of any thickness as long as they have electrical conductivity. In the present embodiment, however, it is intended that the conductive layer 19 has a function to extract the sub X-rays generated at an inner wall surface of the electron path 4 formed in the electron path formation member 3: therefore, the type and thickness of the material of the conductive layer 19 are important.

Material and shape of the target 1 and the electron path formation member 3 are the same as those of the anode 16 according to the first embodiment. The sub X-ray generation surface 5 may be made of a material which is different from that of the electron path formation member 3 as is the case with the first embodiment.

The electron path formation member 3 is provided with an electron path 4 which opens at both ends. Electrons enter from one end of the electron path 4 (i.e., an opening at the electron emission source 6 side) and the target 1 provided at the other end of the electron path 4 (i.e., at the side opposite to the electron emission source 6) is irradiated with the electrons, whereby X-rays are generated. The electron path 4 functions as a path for guiding the electron beam 11 to an electron beam irradiation region (i.e., an X-ray generation area) of the target 1 in an area further toward the electron emission source 6 than the target 1. The shape of the electron path 4 when seen from the electron emission source 6 may be suitably selected from among, for example, circular, rectangular or elliptical. The electron path formation member 3 further has a function to generate the sub X-rays by causing the electrons, which have collided with the target 1 and have been backscatterred at the target 1, to collide with the sub X-ray generation surface 5 of the electron path 4.

In the target area 17, the conductive layer 19 is provided on the support substrate 2, and the target 1 is provided in the central area on the conductive layer 19. In FIGS. 6A and 6B, d1 represents the diameter of the target 1 and d2 represents the inner diameter of the electron path 4. The target area 17 and the electron path formation member 3 are soldered to each other by unillustrated soldering material and therefore inside of the vacuum vessel 9 (see FIG. 1) is kept in a vacuum state. The conductive layer 19 in an area outside a dashed line in FIG. 6B is covered with the electron path formation member 3 when the target area 17 and the electron path formation member 3 are joined to each other.

An electron beam 11 generated by the electron emission source 6 collides with the target 1 via the electron path 4 constituted by the electron path formation member 3, and X-rays 13 are generated at the target 1. A part of the X-rays 13 is attenuated by self-absorption of the target 1 and also by the support substrate 2 which functions also as the X-ray transmission window. However, the degree of such attenuation is small and therefore is tolerated substantially. Desirably, the diameter d1 of the target 1 is substantially the same as that of a cross section of the electron beam 11.

A part of electrons colliding with the target 1 is backscattered, and collides with the inner wall surface of the electron path 4 as backscattered electrons, and generates the sub X-rays from the inner wall surface.

When the sub X-rays pass through the target area 17, some of the sub X-rays pass through two layers, i.e., the conductive layer 19 and the support substrate 2, and the other of the sub X-rays pass through three layers, i.e., the target 1, the conductive layer 19 and the support substrate 2. The target 1 needs to be made of a material with which the electrons collide to efficiently generate X-rays, and needs to have suitable thickness. Therefore, the target 1 needs to be optimized depending on use conditions. Since the electrons rarely collide with the conductive layer 60 to generate X-rays on the conductive layer 60, it is only necessary to consider electrical conductivity and radiolucency, which are inherent characteristics, regarding the conductive layer 60. The energy of the sub X-rays is smaller than the energy of the X-ray emitted from the target 1. Therefore, if the conductive layer 60 and the target 1 are made of the same material and have the same thickness, absorption of the X-rays is great and thus the sub X-rays are not sufficiently taken out.

Desirable materials with high radiolucency that may be used for the conductive layer 19 are light elements, such as aluminum, titanium, silicon nitride, silicon and graphite. The thickness of the conductive layer 19 in a case in which elements that are smaller in mass than the target 1 is used is desirably 0.1 nm to 1 μm. The conductive layer 19 and the target 1 may be made of the same material. If the conductive layer 19 and the target 1 are made of the same material, it is only necessary that the conductive layer 19 is thin enough not to substantially disturb transmission of the X-rays. A metallic material of which atomic number is 26 or greater that is typically used as the target 1 may be used as the conductive layer 19 if the thickness thereof is sufficiently small and, therefore, X-ray transmittance is high. For example, in a case in which tungsten is used, if the thickness of the tungsten layer is 0.1 nm to 0.2 μm, the tungsten layer only slightly shields the X-rays and therefore may be used in the same manner as light elements.

Although the conductive layer 19 is provided on the support substrate 2 and the target 1 is provided on the conductive layer 19 in the present embodiment, these components are not necessarily disposed in this order: it is also possible that the conductive layer 60 is provided to extend from above the target 1 to above the support substrate 2.

If the target 1 is provided on the conductive layer 19, the thickness of the conductive layer 19 in the area covered with the target 1 is desirably 0.1 nm to 0.1 μm. This is because, if the thickness is in the above-described range, favorable linearity and output stability during emission of the X-rays may be provided. Note that the thickness of the conductive layer 19 is not necessarily in the above-described range in the area not covered with the target 1. If the conductive layer 19 and the target 1 are made of the same material, the thickness of the conductive layer 60 in the area covered with the target 1 is not necessarily in the above-described range.

If the conductive layer 19 is provided on the target 1, the thickness of the conductive layer 19 in the area in which the target 1 is covered is desirably 0.1 nm to 0.1 μm. If the conductive layer 19 has the above-described thickness, the X-ray amount generated when the electrons directly collide with the conductive layer 19 is within a tolerance range. The thickness of the conductive layer 19 in an area except for the area in which the target 1 is covered is not necessarily within the above-described range because electrons do not directly collide with the conductive layer 19 in that area. If the conductive layer 19 and the target 1 are made of the same material, the thickness of the conductive layer 19 in an area in which the target 1 is covered is not necessarily within the above-described range.

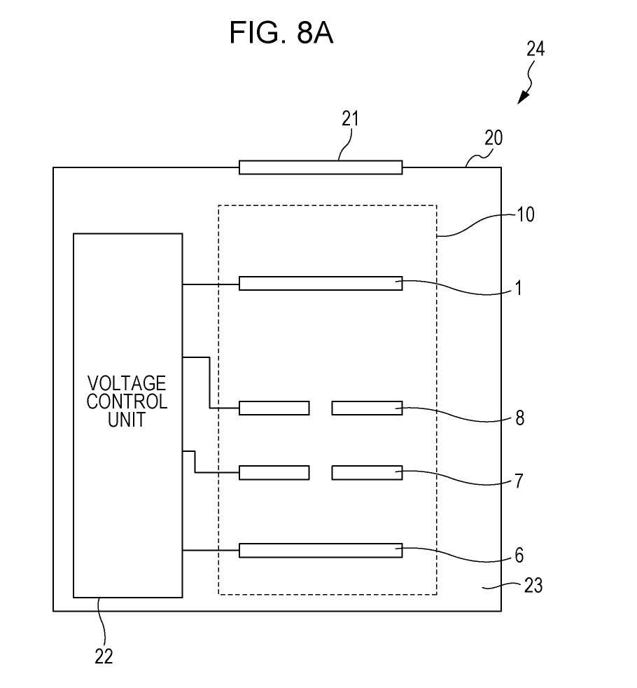

FIGS. 7A and 7B illustrate a modification of the target area 17 illustrated in FIGS. 6A and 6B: FIG. 7A is a cross-sectional view of the target area 17; and FIG. 7B is a plan view of the target area 17 seen from the target 1 side.

The present modification is the same as the example of FIGS. 6A and 6B except for the shape of the conductive layer 19. The conductive layer 19 is provided in the central area on the support substrate 2 and, in addition to this, is provided to extend toward a periphery of the support substrate 2 in a part of an area other than the central area of the support substrate 2. The target 1 is disposed on the conductive layer 19 situated in the central area on the support substrate 2. In the peripheral area on the support substrate 2 which is not covered with the target 1, the conductive layer 19 is disposed at a part of this peripheral area and the rest of this peripheral area is a surface on which the support substrate 2 is exposed.

According to this modification, in the peripheral area on the support substrate 2 which is not covered with the target 1, the conductive layer 19 covers only a part of this peripheral area and the rest of this peripheral area is a surface on which the support substrate 2 is exposed. Then, the sub X-ray transmission rate in this peripheral area is high. Therefore, the sub X-rays generated by the backscattered electrons generated at the target 1 may also be taken out efficiently. In this manner, it is possible to improve X-ray generation efficiency.

### Fourth Embodiment

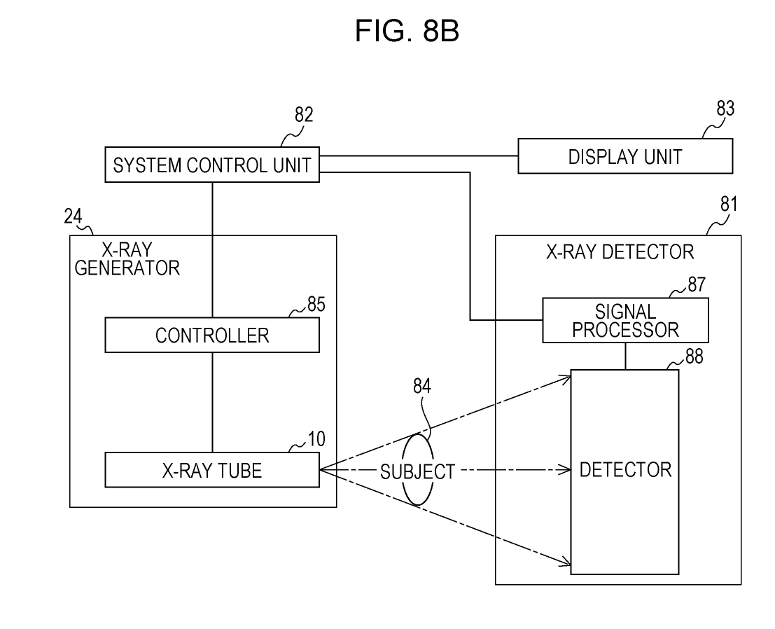

FIG. 8A is a configuration diagram of an X-ray generator of the present embodiment.

In the X-ray generator 24, an X-ray tube 10 is placed inside an outer case 20. The outer case 20 is provided with an X-ray extraction window 21. The X-rays emitted from the X-ray tube 10 pass through the X-ray extraction window 21 and are emitted outside the X-ray generator 24.

An ullage space left after the X-ray tube 10 is disposed inside the outer case 20 may be filled up with an insulating medium 23. For example, an insulating medium and electric insulating oil which has a function as a cooling medium of the X-ray tube 10 are desirably used as the insulating medium 23. Examples of suitable electric insulating oil include mineral oil and silicone oil. Other examples of the insulating medium 23 include fluorine-substrated insulating liquid.

A voltage control unit 22 constituted by, for example, a circuit board and an insulating transformer may be provided inside the outer case 20. The voltage control unit 22 may control generation of the X-rays by applying a voltage signal to the X-ray tube 10. FIG. 8B is a configuration diagram of an X-ray imaging apparatus of the present embodiment. A system control unit 82 controls the X-ray generator 24 and an X-ray detector 81 in coordination with each other. A controller 85 outputs various kinds of control signals to the X-ray tube 10 under the control of the system control unit 82. An emission state of the X-rays emitted from the X-ray generator 10 is controlled by the control signals. The X-rays emitted from the X-ray generator 24 pass through a subject 84 and is detected by a detector 88. The detector 88 converts the detected X-rays into image signals, and outputs the image signals to a signal processor 87. The signal processor 87 carries out predetermined signal processing to the image signals under the control of the system control unit 82, and outputs the processed image signals to the system control unit 82. The system control unit 82 outputs display signals to a display unit 83 so that an image is displayed on the display unit 83 in accordance with the processed image signals. The display unit 83 displays the image in accordance with the display signal on a screen as a captured image of the subject 84. According to the present embodiment, since an X-ray generator with improved X-ray generation efficiency is applied, a compact and high-resolution X-ray imaging apparatus may be provided.

### Example 1

High-pressure synthetic diamond is prepared as the support substrate 2 of the target 1. The high-pressure high-temperature diamond is shaped as a 5-mm-diameter and 1-mm-thick disc (i.e., a cylinder). Organic substances existing on a surface of the diamond are removed in advance using a UV-ozone asher.

On one surface of this diamond substrate, a titanium layer is formed in advance by sputtering using Ar as carrier gas, and then a 8-μm-thick tungsten layer is formed as the target 1. In this manner, the target area 17 is obtained.

A metallized layer is formed to surround the target area 17, and a wax material constituted by silver, copper and titanium is attached thereon. An active metal constituent of the metallized layer is titanium.

A tungsten member is prepared as the electron path formation member 3, and a holding portion of the target area 17 and the electron path 4 are formed. The holding portion is 5.3 mm in diameter. The electron path 4 is formed at various radius R and length Z shown as parameters in Table 1 as conditions 1 to 18.

The target area 17 with the wax material attached thereto is placed onto the thus-configured electron path formation member 3 and sintered at 850 degrees C., to fabricate the anode 16.

Next, as illustrated in FIG. 1, the anode 16 constituted integrally by the target area 17 and the electron path formation member 3 is positioned such that an impregnated thermal-electron gun which is provided with the electron emission source 6 faces the target 1 and that the electron beam 11 is placed inside the electron path 4. The getter is disposed for the sealing and vacuumization. Thus, the X-ray tube 10 is fabricated.

The target area 17 is constituted by the support substrate 2 and the target 1 formed on a surface of the support substrate 2. The target 1 electrically communicates with the electron path formation member 3. The target 1 is disposed on a surface of the support substrate 2 on the side of the electron emission source 6. The electron path formation member 3 is disposed between the target 1 and the electron emission source 6. The electron path formation member 3 surrounds the electron path 4 which opens at both ends. An inner wall surface of the electron path formation member 3 serves as the sub X-ray generation surface 5.

For comparison, an X-ray tube for comparison from which the electron path formation member 3 illustrated in FIG. 1 is excluded is fabricated (condition 19). Finally, in order to estimate the effect of the present invention, the amount of the X-rays obtained by the X-ray tube 10 and the amount of the X-rays obtained by the X-ray tube for comparison are measured. The X-ray amounts are measured using an ionization chamber dosimeter. The X-ray tube 10 and the X-ray tube for comparison are driven with acceleration voltage of 100 kV, current of 5 mA and irradiation time of 100 msec. The diameter of the electron beam is controlled to 0.3 to 2 mm using an electron lens.

Table 1 shows the X-ray amount of the X-ray tube 10 under conditions 1 to 19 against the X-ray amount of the X-ray tube for comparison, which is set at 100. As shown in Table 1, the X-ray amounts are ranged from 104 to 164 under all the conditions 1 to 18 (Example): this means that the X-ray amounts under conditions 1 to 18 are greater than that under condition 19 (Comparative Example) in which no sub-X-ray is generated and from which the electron path formation member 3 is excluded.

### Example 2

The support substrate 2 is the same diamond substrate as that of Example 1 and is treated in the same manner as in Example 1. An 8-micrometer-thick molybdenum layer is formed as the target 1. In this manner, the target area 17 is obtained. Other constitution of the target area 17 is the same as that of Example 1.

A metallized layer is formed to surround the target area 17, and a wax material constituted by silver, copper and titanium is attached thereon. An active metal constituent of the metallized layer is titanium.

A molybdenum member is prepared as the electron path formation member 3, which is the same in dimension and shape as those of Example 1. The radius R of the electron path 4 and the length Z of the electron path 4 are determined under conditions 20 to 37 in accordance with Table 2. The anode 16 is fabricated in the same manner as in Example 1. Thus, the X-ray tube 10 is fabricated. For comparison, an X-ray tube for comparison from which the electron path formation member 3 illustrated in FIG. 1 is excluded is fabricated (condition 38). The X-ray amount of the X-ray tube 10 and the X-ray amount of the X-ray tube for comparison are measured using an ionization chamber dosimeter.

The X-ray tube 10 and the X-ray tube for comparison are driven with acceleration voltage of 40 kV, current of 5 mA and irradiation time of 100 msec. The diameter of the electron beam is controlled to 0.3 to 2 mm using an electron lens.

Table 2 shows the X-ray amount of the X-ray tube 10 under conditions 20 to 38 against the X-ray amount, which is set at 100, of the X-ray tube for comparison which is not provided with the electron path formation member 3. As shown in Table 2, the X-ray amounts are ranged from 103 to 151 under all the conditions 20 to 37 (Example): this means that the X-ray amounts under conditions 20 to 37 are greater than that under condition 38 (Comparative Example) in which no sub-X-ray is generated and from which the electron path formation member 3 is excluded.

### Example 3

The support substrate 2 is the same diamond substrate as that of Example 1 and is treated in the same manner as in Example 1. An 8-micrometer-thick cerium layer is formed as the target 1. In this manner, the target area 17 is obtained. Other constitution of the target area 17 is the same as that of Example 1.

A metallized layer is formed to surround the target area 17, and a wax material constituted by silver, copper and titanium is attached thereon. An active metal constituent of the metallized layer is titanium.

A cerium member is prepared as the electron path formation member 3, which is the same in dimension and shape as those of Example 1. The radius R and the length Z of the electron path 4 are determined under conditions 39 and 40 in accordance with Table 3. The anode 16 is fabricated in the same manner as in Example 1. Thus, the X-ray tube 10 is fabricated. For comparison, an X-ray tube for comparison from which the electron path formation member 3 illustrated in FIG. 1 is excluded is fabricated (condition 41). The X-ray amount of the X-ray tube 10 and the X-ray amount of the X-ray tube for comparison are measured using an ionization chamber dosimeter.

The X-ray tube 10 and the X-ray tube for comparison are driven with acceleration voltage of 40 kV, current of 5 mA and irradiation time of 100 msec. The diameter of the electron beam is controlled to 0.3 to 2 mm using an electron lens.

Table 3 shows the X-ray amount of the X-ray tube 10 under conditions 39 and 40 against the X-ray amount, which is set at 100, of the X-ray tube for comparison which is not provided with the electron path formation member 3. As shown in Table 3, the X-ray amounts under conditions 39 and 40 (Example) are 150 and 143, respectively. The X-ray amounts under conditions 39 and 40 are greater than that under condition 41 (Comparative Example) which is not provided with the electron path formation member 3 that is capable of receiving backscattered electrons.

### Example 4

The support substrate 2 is the same diamond substrate as that of Example 1 and is treated in the same manner as in Example 1. Then, an 8-micrometer-thick lantern layer is formed as the target 1. In this manner, the target area 17 is obtained. Other constitution of the target area 17 is the same as that of Example 1.

A metallized layer is formed to surround the target area 17, and a wax material constituted by silver, copper and titanium is attached thereon. An active metal constituent of the metallized layer is titanium.

A lantern member is prepared as the electron path formation member 3. The radius R and the length Z of the electron path 4 are determined under conditions 42 and 43 in accordance with Table 4. The anode 16 is fabricated in the same manner as in Example 1. Thus, the X-ray tube 10 is fabricated. For comparison, an X-ray tube for comparison from which the electron path formation member 3 illustrated in FIG. 1 is excluded is fabricated (condition 44). The X-ray amount of the X-ray tube 10 and the X-ray amount of the X-ray tube for comparison are measured using an ionization chamber dosimeter.

The X-ray tube 10 and the X-ray tube for comparison are driven with acceleration voltage of 40 kV, current of 5 mA and irradiation time of 100 msec. The diameter of the electron beam is controlled to 0.3 to 2 mm using an electron lens.

Table 4 shows the X-ray amount of the X-ray tube 10 under conditions 42 and 43 against the X-ray amount, which is set at 100, of the X-ray tube for comparison which is provided with no electron path formation member 3. As shown in Table 4, the X-ray amounts under conditions 42 and 43 (Example) are 151 and 144, respectively. The X-ray amounts under conditions 42 and 43 are greater than that under condition 44 (Comparative Example) which is not provided with the electron path formation member 3 that is capable of receiving backscattered electrons.

### Example 5

In this example, as illustrated in FIG. 4, the cross sectional area of the electron path 4 is enlarged continuously toward the target 1. An inner wall surface of an area in which the cross sectional area of the electron path 4 is enlarged serves as the sub X-ray generation surface 5. It is only necessary that at least a part of the inner wall surface of the area in which the cross sectional area of the electron path 4 is enlarged serves as the sub X-ray generation surface 5, and other constitution is the same as that of Example 1. The radius R of the electron path 4 is 1 mm and the length Z of the electron path 4 is 11 mm.

After the X-ray tube 10 is fabricated, the X-ray amount is measured using an ionization chamber dosimeter. The X-ray tube 10 is driven with acceleration voltage of 100 kV, current of 5 mA and irradiation time of 100 msec. The diameter of the electron beam is controlled to 0.3 to 2 mm using an electron lens.

As a result, a greater amount of X-rays are obtained as compared with that obtained by the X-ray tube for comparison fabricated in Example 1.

### Example 6

The anode 16 in this example is illustrated in FIG. 6. The anode 10 is constituted by the support substrate 2, the conductive layer 19, the target 1 and the electron path formation member 3. The support substrate 2 functions also as the X-ray transmission window. The conductive layer 19 is provided for the purpose of preventing charge-up of the target area 17 by the electrons when the target 1 is irradiated with the electron beam 11. Voltage may be applied to the target 1 via the conductive layer 19.

Material and shape of the target 1 and the electron path formation member 3 in this example are the same as those of Example 1. The radius R of the electron path 4 is 1 mm and the length Z of the electron path 4 is 11 mm.

After the X-ray tube 10 is fabricated, the X-ray amount is measured using an ionization chamber dosimeter. The X-ray tube 10 is driven with acceleration voltage of 100 kV, current of 5 mA and irradiation time of 100 msec. The diameter of the electron beam is controlled to 0.3 to 2 mm using an electron lens.

As a result, a greater amount of X-rays are obtained as compared with that obtained by the X-ray tube for comparison fabricated in Example 1.

TABLE 1

| Condition No. | Z (mm) | R (mm) | Z/R | X-Ray amount |
|---|---|---|---|---|
| Condition 1 | 12 | 2 | 6 | 154 |
| Condition 2 | 1 | 2 | 0.5 | 110 |
| Condition 3 | 12 | 1.5 | 8 | 157 |
| Condition 4 | 1 | 1.5 | 0.67 | 120 |
| Condition 5 | 12 | 1 | 12 | 164 |
| Condition 6 | 8 | 1 | 8 | 157 |
| Condition 7 | 4 | 1 | 4 | 150 |
| Condition 8 | 1 | 1 | 1 | 121 |
| Condition 9 | 0.5 | 1 | 0.5 | 110 |
| Condition 10 | 0.1 | 1 | 0.1 | 104 |
| Condition 11 | 12 | 0.5 | 24 | 161 |
| Condition 12 | 8 | 0.5 | 16 | 164 |
| Condition 13 | 4 | 0.5 | 8 | 157 |
| Condition 14 | 1 | 0.5 | 2 | 143 |
| Condition 15 | 0.5 | 0.5 | 1 | 129 |
| Condition 16 | 0.1 | 0.5 | 0.2 | 105 |
| Condition 17 | 12 | 0.3 | 40 | 164 |
| Condition 18 | 1 | 0.3 | 3.33 | 150 |

| | | |
|---|---|---|
| Condition 19 | Target 1 alone (no electron | 100 |
| | path formation member 3) | |

TABLE 2

| Condition No. | Z (mm) | R (mm) | Z/R | X-Ray amount |
|---|---|---|---|---|
| Condition 20 | 12 | 2 | 6 | 142 |
| Condition 21 | 1 | 2 | 0.5 | 108 |
| Condition 22 | 12 | 1.5 | 8 | 145 |
| Condition 23 | 1 | 1.5 | 0.67 | 115 |
| Condition 24 | 12 | 1 | 12 | 151 |
| Condition 25 | 8 | 1 | 8 | 146 |
| Condition 26 | 4 | 1 | 4 | 147 |
| Condition 27 | 1 | 1 | 1 | 117 |
| Condition 28 | 0.5 | 1 | 0.5 | 109 |
| Condition 29 | 0.1 | 1 | 0.1 | 103 |
| Condition 30 | 12 | 0.5 | 24 | 148 |
| Condition 31 | 8 | 0.5 | 16 | 153 |
| Condition 32 | 4 | 0.5 | 8 | 146 |
| Condition 33 | 1 | 0.5 | 2 | 134 |
| Condition 34 | 0.5 | 0.5 | 1 | 123 |
| Condition 35 | 0.1 | 0.5 | 0.2 | 106 |
| Condition 36 | 12 | 0.3 | 40 | 151 |
| Condition 37 | 1 | 0.3 | 3.33 | 140 |

| | | |
|---|---|---|
| Condition 38 | Target 1 alone (no electron | 100 |
| | path formation member 3) | |

TABLE 3

| Condition No. | Z (mm) | R (mm) | Z/R | X-Ray amount |
|---|---|---|---|---|
| Condition 39 | 8 | 1 | 8 | 150 |
| Condition 40 | 4 | 1 | 4 | 143 |

| | | |
|---|---|---|
| Condition 41 | Target 1 alone (no electron | 100 |
| | path formation member 3) | |

TABLE 4

| Condition No. | Z (mm) | R (mm) | Z/R | X-Ray amount |
|---|---|---|---|---|
| Condition 42 | 8 | 1 | 8 | 151 |
| Condition 43 | 4 | 1 | 4 | 144 |

| | | |
|---|---|---|
| Condition 44 | Target 1 alone (no electron | 100 |
| | path formation member 3) | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-189224, filed Aug. 31, 2011, which is hereby incorporated by reference herein in its entirety.

### REFERENCE SIGNS LIST

1 transmission target (target)
2 support substrate
3 electron path formation member
4 electron path
5 sub X-ray generating portion

1. A transmission type X-ray generator comprising an electron path formed by an electron path formation member surrounding a periphery of the electron path, through which electrons having passed are made to irradiate the target so as to generate an X-ray, wherein:
a sub X-ray generating portion which generates an X-ray when being irradiated with electrons backscatterred off the target is provided in the electron path;
the sub X-ray generating portion and the target are disposed in a manner that both an X-ray generated from the target which is directly irradiated with the electrons, and an X-ray generated from the sub x-ray generating portion which is irradiated with the electrons backscatterred off the target are made to be emitted outside; and
a material which constitutes the target and a material which constitutes at least the sub X-ray generating portion of the electron path formation member are the same material of which atomic number is 40 or greater.

2. The X-ray generator according to claim 1, wherein a relationship between a formation length Z of the sub X-ray generating potion from the target and a radius R of the electron path is 2≦Z/R≦20.

3. The X-ray generator according to claim 1, wherein a relationship between the formation length Z of the sub X-ray generating potion from the target and the radius R of the electron path is 4≦Z/R≦20.

4. The X-ray generator according to claim 1, wherein both the target and the electron path formation member are made of any one of Mo, W and lanthanoid.

5. The X-ray generator according to claim 1, wherein the sub X-ray generating portion is formed to extend over an upper side of the target on the side which is irradiated with the electrons.

6. The X-ray generator according to claim 5, wherein a cross sectional area of the electron path at least on the target side is enlarged as compared with that at the side opposite to the target side, and at least a part of an inner wall surface of the area in which the cross sectional area is enlarged is formed as the sub X-ray generating portion.

7. The X-ray generator according to claim 1, wherein 20% to 60% of the emitted electrons are backscattered off the target.

8. The X-ray generator according to claim 1, wherein:
the target is disposed at the central area of the support substrate; and
at least a part of a peripheral area of the support substrate which is not covered with the target is high in transmittance against an X-ray generated from the sub X-ray generating portion as compared with the central area of the support substrate covered with the target.

9. The X-ray generator according to claim 8, wherein a conductive layer connected to the target is provided in at least a part of a peripheral area of the support substrate which is not covered with the target.

10. The X-ray generator according to claim 9, wherein the thickness of the conductive layer is greater than that of the target.

11. An X-ray imaging apparatus comprising:
an X-ray generator according to claim 1;
an X-ray detector which detects an X-ray which is emitted from the X-ray generator and which passes through a subject; and
a control unit which controls the X-ray generator and the X-ray detector in coordination with each other.
